(19) United States
(12) Patent Application Publication
(10) Pub. No.: US 2007/0050678 A1
(43) Pub. Date: Mar. 1, 2007

(54) Apparatus for self-diagnosis and treatment of critical software flaws

(75) Inventors: Charles D. Estes, Fort Lauderdale, FL (US); Josue Pena, Pembroke Pines, FL (US); Ruiqiang Zhuang, Coral Springs, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/213,192

(22) Filed: Aug. 25, 2005

(51) Int. Cl. G06F 11/00

(52) U.S. Cl. 714/38

(57) ABSTRACT

A method (200) and a system (100) for repairing a flaw in software (120). A failure during execution of the software can be automatically identified, and a state of the software execution at a point of the software failure can be frozen. A failure handling application (130) can be automatically executed, without disrupting the frozen state of the software execution. Incident data that correlates to the frozen state of the software can be generated. For example, at least one state indicator available in the frozen state can be collected into an incident report (140). The incident report can be sent to a flaw database (145). A software patch (150) selected based on the incident data can be automatically received, for instance from the flaw database. The software can be automatically updated with the software patch. Execution of the software can be automatically reinitialized in response to the software update.

### BACKGROUND OF THE INVENTION

1. Field OF the Invention

The present invention generally relates to software systems and, more particularly, to systems that perform software updates.

2. Background of the Invention

Oftentimes software that is released for use contains flaws, or bugs. Such flaws can result in software that ceases to properly function under certain circumstances. In many instances, software fixes for particular flaws are available in the form of software updates, even before some users experience problems caused by the flaws that are being corrected. One or more software updates are sometimes delivered to a user's machine in the form of a software patch. Not all software users regularly update their software, however. In consequence, such users experience a higher rate of software failures in comparison to users who keep their systems updated with the latest software patches.

Not all software updates are necessary for every system, though. For example, some software updates are applicable only to specific types of hardware. Thus, users who take time to download and install every available software update may be doing so unnecessarily. This can represent a significant amount of wasted time since such software updates often require the user to reboot the system on which the software update is being installed.

### SUMMARY OF THE INVENTION

The present invention relates to a method and a system for repairing a flaw in software. The method can include automatically identifying a failure during execution of the software, and automatically freezing a state of the software execution at a point of the software failure. In response to the failure identification, a failure handling application can be automatically executed, without disrupting the frozen state of the software execution.

Incident data that correlates to the frozen state of the software can be automatically generated. For example, at least one state indicator available in the frozen state can be collected into an incident report, and the incident report can be sent to a flaw database. A software patch that is selected based on the incident data can be automatically received, for instance from the flaw database. The software can be automatically updated with the software patch. Execution of the software can be automatically reinitialized in response to the software update.

The software update system can include a software monitor that automatically identifies a failure during execution of software, and automatically freezes a state of the software execution at a point of the software failure. The system also can include a failure handling application that is executed in response to the software monitor identifying the failure. The failure handling application can be executed without disrupting the frozen state of the software execution.

The failure handling application can automatically generate incident data that correlates to the frozen state of the software, automatically receive a software patch that is selected based on the incident data, and automatically update the software with the software patch. The failure handling application also can automatically collect at least one state indicator available in the frozen state into an incident report to generate the incident data. The failure handling application can send the incident report to a flaw database. In addition, the failure handling application can receive the software patch from the flaw database. The failure handling application also can automatically reinitialize execution of the software in response to the software update.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 is a block diagram of a software update system which is useful for understanding the present invention.

FIG. 2 is a flowchart that presents a software update method which is useful for understanding the present invention.

### DETAILED DESCRIPTION

The present invention relates to a method and a system for automatically diagnosing and repairing software flaws when a device experiences a software failure. In particular, the system can automatically identify a software failure that occurs during execution of the software. In response, the system can freeze the state of the software execution at the point of the software failure, and execute a failure handling application. The failure handling application can communicate incident data correlating to the frozen state of the failed software to a flaw database, and receive a software patch for updating the failed software. Once the software patch has been implemented, execution of the software can be reinitialized.

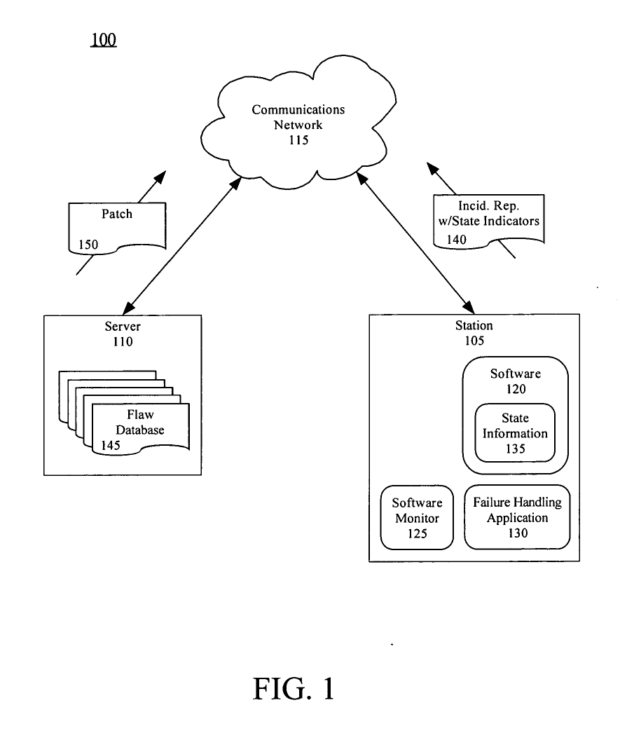

Referring to FIG. 1, a block diagram of a software update system 100 is presented. The software update system 100 can include a station 105 and a server 110 that communicate via a communications network 115. The communications network 115 can include landline and/or wireless communication links. For example, the communications network 115 can be a mobile radio communications network, a cellular telephone communications network, a telemetry system, a wide area network (WAN), a local area network (LAN), a wireless LAN (WLAN), an intranet, the Internet, or any other suitable communications network.

The station 105 can be, for example, a mobile telephone, a personal digital assistant (PDA), a computing device, an embedded device, or any other system or device that can communicate with the server 110 over the communications network 115 and that can execute software 120. The software 120 can be, for example, an operating system or an executable application.

The station 105 can include a software monitor 125 that monitors the software 120. The software monitor 125 can be implemented in firmware that is provided for the station 105, or in an operating system executing on the station 105. For example, the software monitor 125 can be implemented in a low level of the operating system and monitor other components of the operating system, as well as executable software applications.

The software monitor 125 can monitor the software 120 to identify if, and when, a failure occurs during execution of the software 120. In response to detecting such a failure, the software monitor 125 can freeze a state of the software execution at the point where the software failure occurred, and execute a failure handling application 130. The failure handling application 130 can be implemented in firmware, the operating system, or as a standalone application operating on the station 105.

If, after the software failure, the station 105 is sufficiently operable to execute the failure handling application 130, the failure handling application 130 can be executed without a reboot of the station 105, and without disrupting the frozen state of the software 120. If, however, the station 105 is not sufficiently operable after the software failure, the station 105 can reboot into a safe mode in which the software 120 is not executed, or in which the software 120 is executed with only certain functions active. For example, when a software failure occurs, the software monitor 125 can communicate with the failure handling application 130 to determine whether the failure handling application can adequately implement software updates in the current system state. If not, the software monitor 125 can initiate a reboot of the station into the safe mode.

In an arrangement in which the station 105 is a wireless communication device, but the software failure causes the wireless networking capabilities of the station 105 to be compromised, another device or system (not shown) may be connected to the station 105 to facilitate communication with the server 115. For instance, the station 105 may be connected to a personal computer that communicates with the server 105 via the communications network 115. In this arrangement, one or more portions the failure handling application 130 can be implemented by the device or system to which the station 105 is connected.

The failure handling application 130 can examine the frozen software 120 and automatically collect state information 135 representative of the state of the software 120 at the time the software 120 was frozen. For instance, the software 120 can be provided with indicators that represent the most recent state of the software 120, and that are accessible when the software 120 is frozen. In one arrangement, the indicators can be contained in a data table or text file maintained by the software 120. When a software failure occurs and the software 120 is frozen, the failure handling application 130 can access the data table or text file to retrieve the state information 135.

If the software 120 must be restarted in safe mode to perform the software update, the indicators representing the state of the software at the time of the failure can be preserved. For example, the data table or text file can be copied to a backup file when the software 120 is restarted, or the data logging can be turned off in the software 120 during safe mode operation to prevent the state information 135 representing the frozen state of the software 120 from being overwritten.

The failure handling application 130 can process the state information 135 and generate an incident report 140, which can include state indicators correlating to the frozen state of the software 120. The failure handling application 130 can send the incident report 140 to the server 110 via the communications network 115. In particular, the incident report 140 can be sent to a flaw database 145 executing on the server 110. In another arrangement, the flaw database 145 can execute on a system communicatively linked to the server 110.

The flaw database 145 can evaluate the state indicators contained in the incident report 140 and automatically select a software patch 150 for repairing the failed software 120. For instance, the state indicators can be compared to incident data associated with various software flaws identified in the flaw database 145 to identify one or more flaws affecting the software 120. The flaw database 145 then can select software updates that correct the flaws and send the software updates to the failure handling application 130 in the software patch 150. The failure handling application then can update the software 120 with the software patch 150, and the software 120 can be reinitialized.

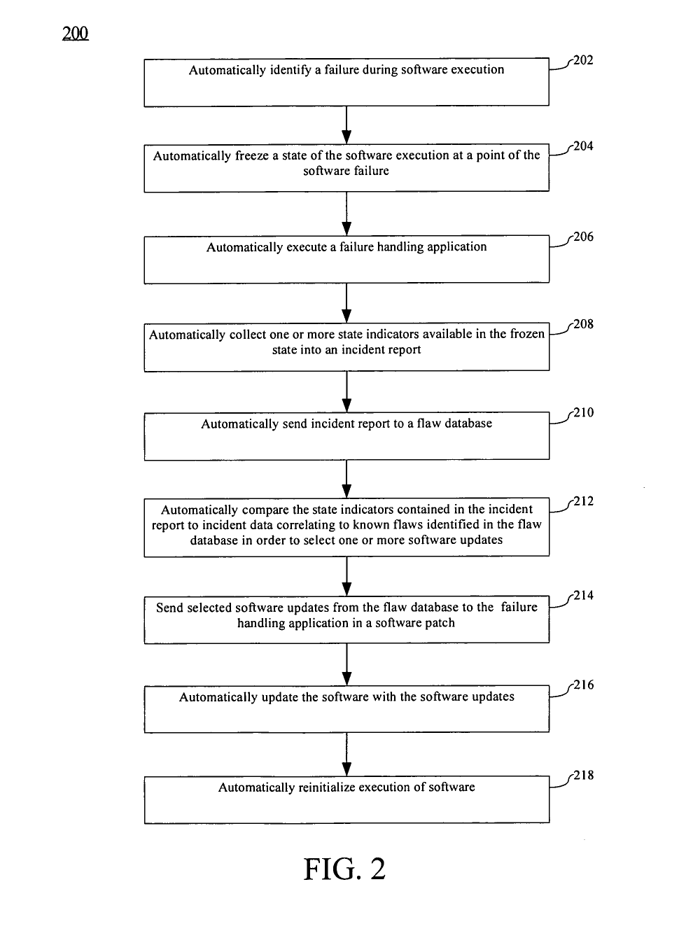

Referring to FIG. 2, a software update method 200 is presented which is useful for understanding the present invention. Beginning at step 202, a failure during software execution can be automatically identified, for example by the software monitor. Proceeding to step 204, a state of the software execution can be automatically frozen at the point of the software failure, and a failure handling application can be automatically executed, as shown in step 206. The failure handling application can be executed without disrupting the frozen state of the software execution.

Referring to step 208, the failure handling application can automatically collect into an incident report one or more state indicators available while the software is in the frozen state. At step 210, the incident report can be automatically sent to the flaw database. Proceeding to step 212, the state indicators can be automatically compared to incident data correlating to known flaws identified in the flaw database. The results of the comparison can be used to automatically select one or more software updates that may be applicable for repairing the failed software. The selected software updates can be automatically sent from the flaw data base to the station in a software patch, as shown in step 214. For instance, the software updates can be sent to the failure handling application.

At step 216, the failure handling application can automatically update the failed software with the software updates. Continuing to step 218, execution of the failed software can be automatically reinitialized.

The present invention can be realized in hardware, software, or a combination of hardware and software. The present invention can be realized in a centralized fashion in one system, or in a distributed fashion where different elements are spread across several interconnected systems. Any kind of processing device or other apparatus adapted for carrying out the methods described herein is suited. A typical combination of hardware and software can be a processing device with an application that, when being loaded and executed, controls the processing device such that it carries out the methods described herein.

The present invention also can be embedded in an application program product, which comprises all the features enabling the implementation of the methods described herein, and which when loaded in a processing device is able to carry out these methods. Application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for repairing a flaw in software comprising:
automatically identifying a failure during execution of the software;
automatically freezing a state of the software execution at a point of the software failure;
automatically generating incident data that correlates to the frozen state of the software;
automatically receiving a software patch that is selected based on the incident data; and
automatically updating the software with the software patch.

2. The method according to claim 1, wherein said step of automatically generating incident data comprises collecting at least one state indicator available in the frozen state into an incident report.

3. The method according to claim 2, further comprising sending the incident report to a flaw database.

4. The method according to claim 1, wherein said step of automatically receiving a software patch comprises receiving the software patch from a flaw database.

5. The method according to claim 1, further comprising automatically executing a failure handling application in response to said step of automatically identifying a failure.

6. The method according to claim 5, wherein said step of automatically executing a failure handling application comprises executing the failure handling application without disrupting the frozen state of the software execution.

7. The method according to claim 1, further comprising automatically reinitializing execution of the software in response to said step of automatically updating the software.

8. A software update system comprising:
a software monitor that automatically identifies a failure during execution of software and automatically freezes a state of the software execution at a point of the software failure; and
a failure handling application that automatically generates incident data that correlates to the frozen state of the software, automatically receives a software patch that is selected based on the incident data, and automatically updates the software with the software patch.

9. The system of claim 8, wherein said failure handling application automatically collects at least one state indicator available in the frozen state into an incident report to generate said incident data.

10. The system of claim 9, wherein said failure handling application sends the incident report to a flaw database.

11. The system of claim 8, wherein said failure handling application receives the software patch from a flaw database.

12. The system of claim 8, wherein said failure handling application is executed in response to said software monitor identifying the failure.

13. The system of claim 12, wherein said failure handling application is executed without disrupting the frozen state of the software execution.

14. The system of claim 8, wherein said failure handling application automatically reinitializes execution of the software in response to the software update.

15. A machine readable storage, having stored thereon a computer program having a plurality of code sections executable by a machine for causing the machine to perform the steps of:
automatically identifying a failure during execution of the software;
automatically freezing a state of the software execution at a point of the software failure;
automatically generating incident data that correlates to the frozen state of the software;
automatically receiving a software patch that is selected based on the incident data; and
automatically updating the software with the software patch.

16. The machine readable storage of claim 15, wherein said step of automatically generating incident data comprises collecting at least one state indicator available in the frozen state into an incident report.

17. The machine readable storage of claim 16, further causing the machine to perform the step of sending the incident report to a flaw database.

18. The machine readable storage of claim 15, wherein said step of automatically receiving a software patch comprises receiving the software patch from a flaw database.

19. The machine readable storage of claim 15, further causing the machine to perform the step of automatically executing a failure handling application in response to said step of automatically identifying a failure.

20. The machine readable storage of claim 15, wherein said step of automatically executing a failure handling application comprises executing the failure handling application without disrupting the frozen state of the software execution.
